(19) United States
(12) Patent Application Publication
(10) Pub. No.: US 2026/0354343 A1
(43) Pub. Date: Nov. 12, 2026

(54) PET HAIR REMOVER

(71) Applicant: Qianlong CUI, Fuyang (CN)

(72) Inventor: Qianlong CUI, Fuyang (CN)

(21) Appl. No.: 19/201,024

(22) Filed: May 7, 2025

(51) Int. Cl. A01K 13/00; A46B 5/00; A46B 13/00; A46B 13/04; A46B 15/00

(52) U.S. Cl. CPC A01K 13/002; A46B 5/0012; A46B 13/001; A46B 13/04; A46B 15/0004; A46B 15/0053; A46B 2200/1093

(57) ABSTRACT

The present disclosure provides a pet hair remover, including a housing, a circuit board, a bristle component, a hair suction component, an atomization assembly and a detection member. It also has a liquid storage compartment, with a mounting compartment and a storage compartment arranged inside. An adsorption portion is arranged between the mounting compartment and the storage compartment. One side of the housing has a connecting portion configured for connecting with a mounting platform. A plurality of first brush heads are distributed on the bristle plate, and a plurality of second brush heads are distributed on the bristle roller. A spray nozzle, a detection member and a plurality of flow grooves are arranged on the bristle component and/or the housing.

### TECHNICAL FIELD

The present disclosure relates to the technical field of pet products, and in particular to a pet hair remover.

### BACKGROUND

As people's living standards improve, the demand for emotional companionship has been increasing, leading to the popularity of companion animals, represented by cats and dogs, among many individuals.

Pets'skin is typically covered with dense fur, which can easily become tangled during playtime. This not only compromises their appearance but may also affect their health. Therefore, pet grooming brushes are commonly required to maintain their furs.

### SUMMARY

A first aspect of the present disclosure provides a pet hair remover, including a housing, a circuit board, a bristle component, an atomizer, and at least one sensor. The housing defines a first accommodating space inside, one side of the first accommodating space defines a mounting port to allow the first accommodating space to be in communication with an outside of the housing, the first accommodating space includes a mounting compartment, a connecting portion is provided on one side of the housing, the connecting portion is configured to be connected to a mounting platform. The liquid storage compartment is configured for storing a liquid. The circuit board is installed in the mounting compartment. The bristle component includes a bristle plate and a plurality of first brush heads, the bristle plate is disposed in the mounting port, the plurality of first brush heads are evenly distributed on one side of the bristle plate and extending to the outside of the housing, the bristle plate and/or the housing are/is provided with a spray nozzle and a detection member, and the spray nozzle communicates with the liquid storage compartment via a guide channel. The atomizer includes an atomization element, the atomization element is disposed in the liquid storage compartment and/or the guide channel, the atomization element is electrically connected to the circuit board, and the atomization element is configured to atomize the liquid in the liquid storage compartment. The at least one sensor is disposed in the detection member, the at least one sensor is electrically connected to the circuit board, and the at least one sensor is one or more of a visual sensor, an optical sensor, a pressure sensor, a chip sensor, an infrared sensor or a microwave sensor.

A second aspect of the present disclosure provides a pet hair remover, including: a housing, a circuit board, a hair suction component, a bristle component, and at least one sensor. The housing defines a first accommodating space inside, a sidewall of the housing defines an air outlet and a mounting port in communication with the first accommodating space respectively, the first accommodating space includes an mounting compartment and a hair storage space, the mounting compartment is in communication with an outside of the housing through the air outlet, the hair storage space includes an adsorption portion and a storage compartment, the storage compartment is in communication with the outside of the housing through the mounting port, the adsorption portion is arranged between the mounting compartment and the storage compartment, a connecting portion is arranged on one side of the housing, and the connecting portion is configured to connect to a mounting platform. The circuit board is disposed in the mounting compartment. The hair suction component is disposed in the mounting compartment, the hair suction component includes a first motor and a fan blade, the first motor is electrically connected to the circuit board, and the fan blade is mounted on an output shaft of the first motor. The bristle component includes a bristle plate and a plurality of first brush heads, the bristle plate is arranged at the mounting port, the plurality of first brush heads are evenly distributed on one side facing away from the storage compartment of the bristle plate, and the plurality of first brush heads extend to the outside of the housing, the bristle plate and/or the housing are/is provided with a detection member, and a peripheral of the housing and/or the bristle plate define/defines a plurality of flow grooves. The at least one sensor is arranged at the detection member, the at least one sensor is electrically connected to the circuit board, and the at least one sensor includes one or more of a visual sensor, an optical sensor, a pressure sensor, a chip sensor, an infrared sensor or a microwave sensor.

A third aspect of the present disclosure provides a pet hair remover, including: a housing, a circuit board, a bristle component, a hair suction component, and at least one sensor. The housing has a first accommodating space inside, the first accommodating space includes a mounting compartment and a storage compartment, a connecting portion is provided on one side of the housing, the connecting portion is configured to connect with a mounting platform. The circuit board is installed in the mounting compartment. The bristle component includes a bristle roller and a plurality of second brush heads, the bristle roller is pivoted to the mounting port, the plurality of second brush heads is evenly distributed on a circumferential surface of the bristle roller, a detection member is provided on the housing and/or the bristle component. A side of the mounting compartment away from the storage compartment defines an air outlet, the mounting compartment is communicated with an outside of the housing through the air outlet, a periphery of the housing and/or the bristle component define/defines a plurality of flow grooves, an adsorption portion is provided between the mounting compartment and the storage compartment, the hair suction component is installed in the mounting compartment, the hair suction component includes a first motor and a fan blade, the first motor is electrically connected to the circuit board, and the fan blade is installed on an output shaft of the first motor. The bristle component further includes a second motor, a motor mounting platform is provided at a rotating shaft of the bristle roller, the second motor is coupled to the rotating shaft of the bristle roller through the motor mounting platform, and the second motor is electrically connected to the circuit board. The at least one sensor is disposed in the detection member, the at least one sensor is electrically connected to the circuit board, and the at least one sensor includes one or more of a visual sensor, an optical sensor, a pressure sensor, a chip sensor, an infrared sensor or a microwave sensor.

### BRIEF DESCRIPTION OF DRAWINGS

The drawings constituting part of the present disclosure are configured to provide a further understanding of the embodiments of the present disclosure. The schematic embodiments of the present disclosure and their descriptions are configured to explain but do not constitute an improper limitation of the present disclosure.

FIG. 1 is a first perspective view of a pet hair remover according to some embodiments of the present disclosure.

FIG. 2 is a second perspective view of a pet hair remover according to some embodiments of the present disclosure.

FIG. 3 is a third perspective view of a pet hair remover according to some embodiments of the present disclosure.

FIG. 4 is a fourth perspective view of a pet hair remover according to some embodiments of the present disclosure.

FIG. 5 is a perspective view of a pet hair remover according to a first embodiment of the present disclosure.

FIG. 6 is a perspective view of a pet hair remover according to a second embodiment of the present disclosure.

FIG. 7 is a perspective view of a pet hair remover according to a third embodiment of the present disclosure.

FIG. 8 is a perspective view of a pet hair remover according to a fourth embodiment of the present disclosure.

FIG. 9 is a perspective view of a pet hair remover according to a fifth embodiment of the present disclosure.

FIG. 10 is a perspective view of a pet hair remover according to a sixth embodiment of the present disclosure.

FIG. 11 is a sectional view of a pet hair remover according to some embodiments of the present disclosure.

FIG. 12 is a partial enlarged view of part A in FIG. 11.

FIG. 13 is a second sectional view of a pet hair remover according to some embodiments of the present disclosure.

FIG. 14 is a perspective view of a pet hair remover according to some embodiments of the present disclosure.

FIG. 15 is a perspective view of a control panel of a pet hair remover according to some embodiments of the present disclosure.

### DETAILED DESCRIPTION OF THE EMBODIMENTS

The present disclosure may be described in detail below with reference to the accompanying drawings and in conjunction with various embodiments. Each example is provided to explain but not limit the present disclosure. In fact, it may be clear to those of ordinary skill that modifications and variations may be made without departing from the scope or spirit of the present disclosure. For example, a feature shown or described as part of one embodiment may be used according to another embodiment to produce yet another embodiment. Therefore, it is intended that the present disclosure includes such modifications and variations within the scope of the appended claims and their equivalents.

In the description of the present disclosure, the terms “longitudinal”, “lateral”, “upper”, “lower”, “front”, “back”, “left”, “right”, “vertical”, “horizontal”, “top”, “bottom” and the like indicate the orientational or positional relationship based on the orientational or positional relationship illustrated in the drawings, which is only for the convenience of describing and does not require the present disclosure to be constructed and operated in a specific orientation, and therefore cannot be understood as limiting the present disclosure. The terms “connected”, “connecting” and “arranged” used in the present disclosure should be understood in a broad sense. For example, it may be a fixed connection or a detachable connection; it may be directly connected or indirectly connected through an intermediate component; it may also be a wired electrical connection, a radio connection, or a wireless signal connection. For those of ordinary skill in the art, the specific meanings of the above terms may be understood according to the specific circumstances.

One or more examples of the present disclosure are illustrated in the attached drawings. Numbers and letter signs are used in the detailed description to refer to features in the drawings. Similar signs in the drawings and descriptions have been configured to refer to similar parts of the present disclosure. As used herein, the terms “first”, “second” and “third” are used interchangeably to distinguish one component from another and are not intended to indicate the position or importance of individual components.

A grooming brush in the related art has structural limitations that often lead to residual shed hair remaining on the brush itself, clinging to a user' clothing, or scattering everywhere. These loose hairs are particularly difficult to clean up, consequently increasing the cleaning burden for a pet owner.

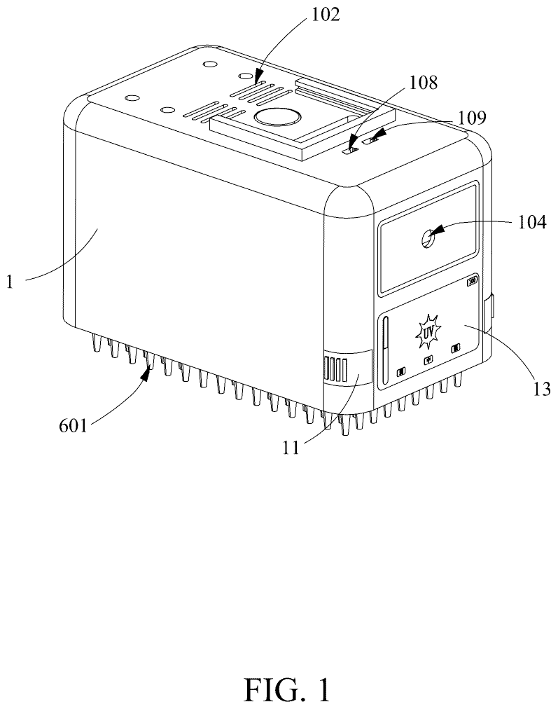

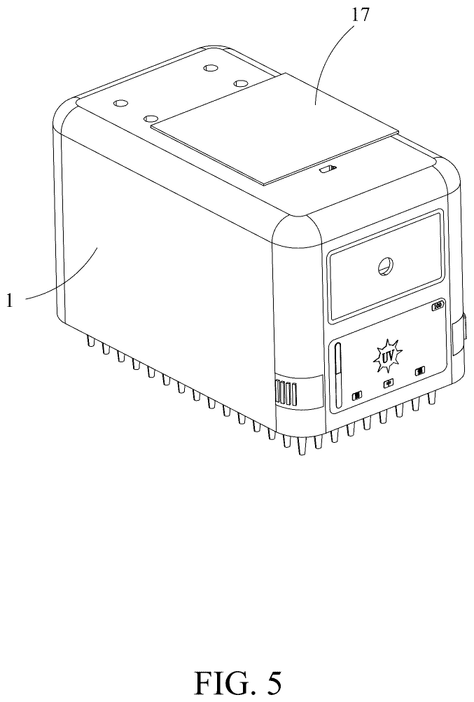

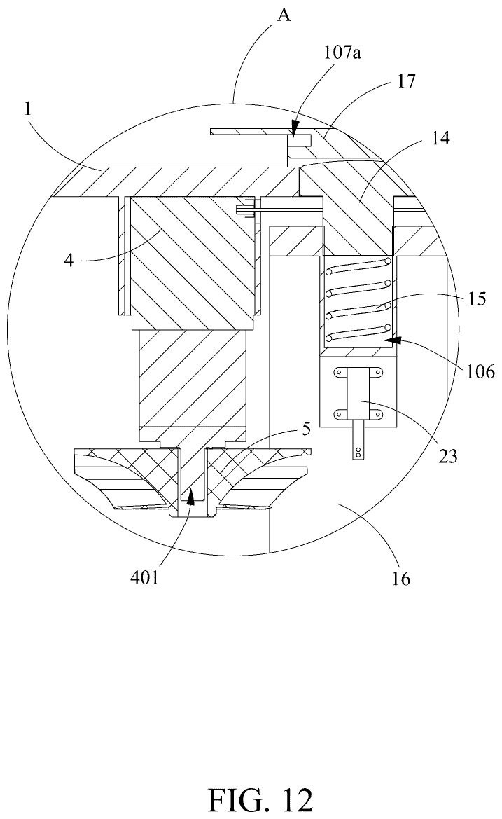

As illustrated in FIG. 1 to FIG. 15, some embodiments of the present disclosure provide a pet hair remover, which includes a housing 1, an adsorption portion 2, a circuit board 3, a hair suction component, a bristle component, and a control panel 13.

As illustrated in FIG. 1 to FIG. 14, the housing 1 is formed by injection molding. Opposing sides of the housing 1 are respectively defined with an air outlet 102 and a mounting port 110, allowing a first accommodating space 101 inside the housing 1 to be in communication with an outside of the housing 1. The adsorption portion 2 can be disposed in the housing 1 by inserting, gluing or threading, thereby dividing the first accommodating space 101 inside the housing into a mounting compartment 101a for installing electronic components and a storage compartment 101b for collecting pet hair. The control panel 13 is arranged on one side of the housing 1 and is electrically connected to the circuit board 3. The control panel 13 can be powered by the circuit board 3 and control the circuit board 3. The control panel 13 is provided with a status icon and a control button.

In some embodiments, the outer wall, corresponding to the storage compartment 101b, of the housing 1 is made of a material with high transparency, facilitating directly observing the collection of hair and other foreign objects in the storage compartment 101b from outside. Therefore, the hair and other foreign objects in the storage compartment 101b can be cleaned in time.

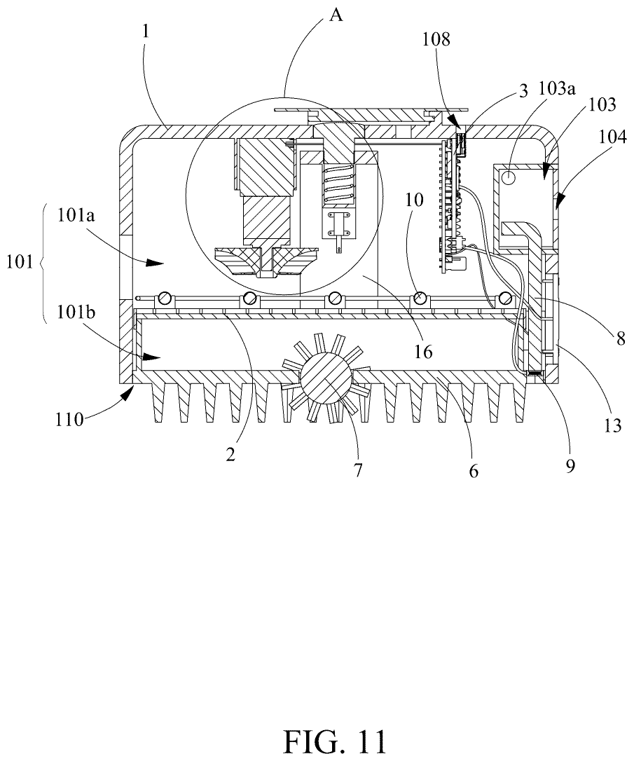

In some embodiments, as illustrated in FIG. 1 and FIG. 11, the circuit board 3 and the hair suction component are mounted in the mounting compartment 101a. The circuit board 3 is integrated with a lithium battery and a USB power supply interface. The housing 1 is provided with a charging port 108 and a discharging port 109 through which a USB interface can be inserted. The charging port 108 is configured to directly power the circuit board 3 or charge the lithium battery integrated thereon, and other electronic components can also be powered through the circuit board 3 and the discharging port 109. The hair suction component includes a first motor 4 and a fan blade 5. The first motor 4 is electrically connected to the circuit board 3 to allow the circuit board 3 to power the first motor 4. The fan blade 5 is mounted on an output shaft 401 of the first motor 4. When the circuit board 3 powers the first motor 4, the fan blade 5 rotates to create a negative pressure environment within the first accommodating space 101, thereby generating an airflow path from the mounting port 110 to the first accommodating space 101. Through the filtration mechanism of the adsorption portion 2, airborne contaminants such as hair particles carried by the airflow are trapped and accumulated in the storage compartment 101b, while the filtered airflow is exhausted via the air outlet 102 of the housing 1.

In some embodiments, the adsorption portion 2 is a single-layer or multi-layer loose porous object made of one or more porous materials such as felt, sponge or activated carbon. These materials ensure that the airflow passing therethrough can be filtered.

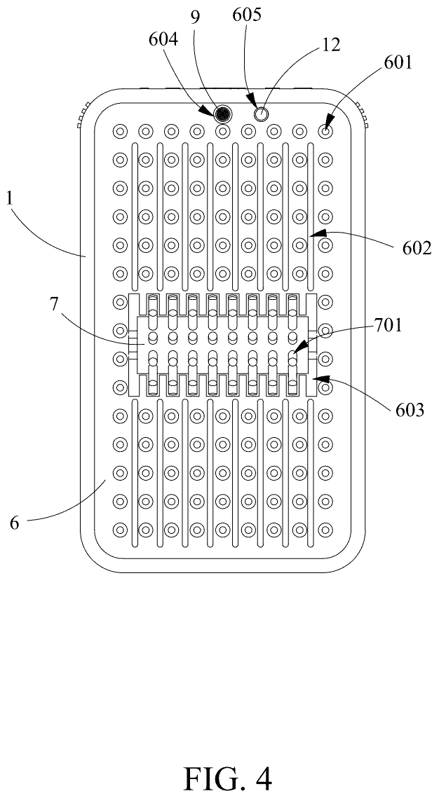

In some embodiments, as illustrated in FIG. 4, the bristle component includes a bristle plate 6, a plurality of first brush heads 601, a bristle roller 7 and a plurality of second brush heads 701.

In some embodiments, as illustrated in FIG. 1 to FIG. 5, the bristle plate 6 is detachably mounted on the mounting port 110 of the housing 1 by an insertion or threaded fastening mechanism, forming a seal over the storage compartment 101b. The plurality of first brush heads 601 are evenly arranged on the bristle plate 6. A middle of the bristle plate 6 is defined with a first mounting groove 603. The bristle roller 7 is pivotally mounted in the first mounting groove 603 through an axial hole, enabling an unconstrained pivotal movement of the bristle roller 7 relative to the bristle plate 6. The plurality of second brush heads 701 are evenly distributed on a circumferential surface of the bristle roller 7. The bristle plate 6 is defined with a plurality of flow grooves 602, and the plurality of flow grooves 602 are evenly arranged between each row or column of the plurality of first brush heads 601. When the fan blade 5 rotates to create a negative pressure differential within the first accommodating space 101, inducing an external airflow outside the housing 1 to flow into the storage compartment 101b through the plurality of flow grooves 602. This configuration ensures that, driven by the airflow, debris such as residual hair deposits on the first brush heads 601 and the second brush heads 701 are conveyed into the storage compartment 101b via the plurality of flow grooves 602. When it is necessary to clean the hair and other airflow-entrained contaminants in the storage compartment 101b or replace the adsorption portion 2, the bristle component can be removed.

In some embodiments, as illustrated in FIG. 4, a detection member 605 is provided on the bristle plate 6, and a sensor 12 is installed in the detection member 605. The sensor 12 is electrically connected to the circuit board 3 to allow the circuit board 3 to power the sensor 12. When detecting a pet's grooming or rubbing motions, the sensor 12 transmits an electrical signal to the circuit board 3, enabling the circuit board 3 to automatically power the electronic components such as the first motor 4, an atomizing sheet 9 and a second ultraviolet lamp 10, thereby automatically turning on the corresponding function of each electronic component.

In some embodiments, a plurality of detection members 605 and sensors 12 are arranged, and the plurality of sensors 12 can be a combination of a visual sensor, an optical sensor, a pressure sensor, a chip sensor or an infrared sensor.

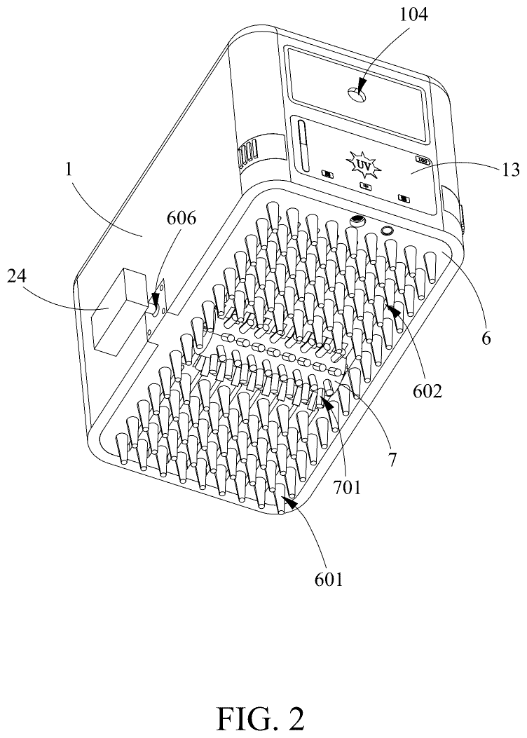

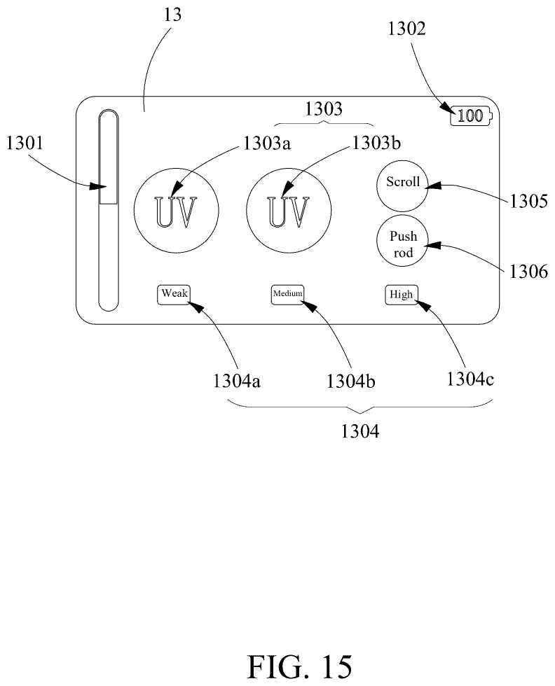

In some embodiments, as illustrated in FIG. 2 and FIG. 15, one side, axially aligned with the rotating shaft of the bristle roller 7, of the bristle plate 6 is arranged with a motor mounting platform 606. A second motor 24 is externally mounted via the motor mounting platform 606. The second motor 24 is connected to the rotating shaft of the bristle roller 7, electrically connected to the circuit board 3, and can be powered by the circuit board 3 and the discharging port 109. When the sensor 12 detects a pet's rubbing motion, the second motor 24 drives the bristle roller 7 to automatically roll to remove hair and massage the pet. The working principle of the intermittent sensing spray is based on setting a sensing interval, and each sensing triggers a spray, and automatically stop until a preset duration is reached. After a preset interval, such as 20 minutes, the intermittent sensing spray is repeated. The working principle of the intermittent sensing hair suction is based on setting a sensing interval, and each sensing triggers a hair suction, and automatically stop until a preset duration is reached. After a preset interval, such as 10 minutes, the intermittent sensing hair suction is repeated. The control buttons on the control panel 13 include a scroll switch 1305, allowing a user to control whether the bristle roller 7 can be automatically activated by the sensor 12.

In some embodiments, the first brush head 601 and/or the second brush head 701 are/is made of materials such as fiber and/or silicone. The first brush head 601 and/or the second brush head 701 are/is formed by fiber bundling or by silicone injection molding. The first brush head 601 and/or the second brush head 701 are/is cylindrical, conical, pin-shaped or polygonal. The first brush head 601 is integrally injection molded with the bristle plate 6 or inserted into the bristle plate 6. The second brush head 701 is integrally injection molded with the bristle roller 7 or inserted into the bristle roller 7.

In some embodiments, a length of the first brush head 601 and the second brush head 701 ranges from 0.2 cm to 10 cm.

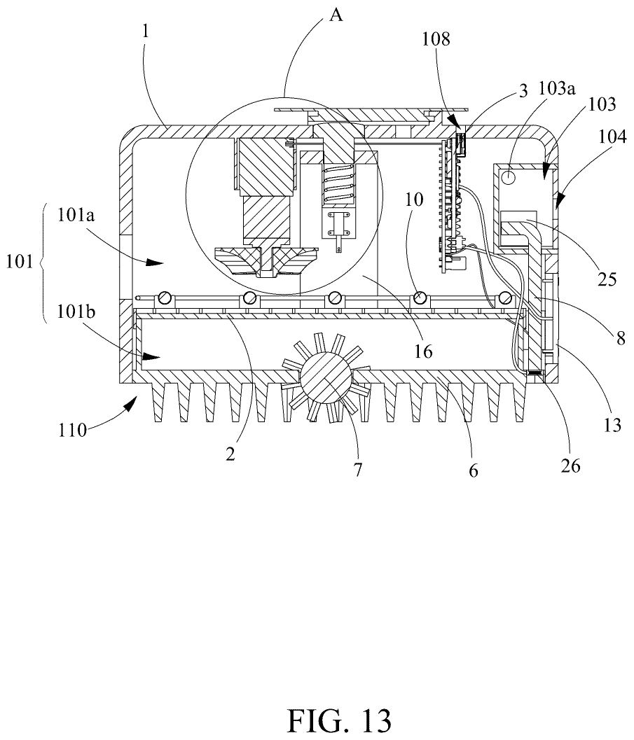

In some embodiments, as illustrated in FIG. 11 and FIG. 13, a liquid storage compartment 103 is further disposed inside the housing 1. One side of the liquid storage compartment 103 is defined with a liquid injection port 104 communicating with the outside of the housing 1. The liquid injection port 104 allows liquid to be poured into the liquid storage compartment 103 or liquid within the liquid storage compartment 103 to be discharged out.

In some embodiments, as illustrated in FIG. 4 and FIG. 11, the bristle plate 6 is defined with a spray nozzle 604, a guide channel 8 is disposed in the liquid storage compartment 103, and the spray nozzle 604 is in communication with the liquid storage compartment 103 via the guide channel 8. One end, proximal to the spray nozzle 604, of the guide channel 8 is incorporated with an atomizer sheet 9. The atomizer sheet 9 is electrically connected to the circuit board 3, enabling the circuit board 3 to supply power to the atomizer sheet 9. The atomizer sheet 9 can atomize the water in the guide channel 8 flown from the liquid storage compartment 103 and discharge the mist through the spray nozzle 604. When a pet is grooming or rubbing the bristle component, the mist sprayed from the spray nozzle 604 wets the pet's hair, clean and prevent the pet's hair from splashing. The guide channel 8 can be a piped conduit, an integrated flow passage or a semi-open trough, each providing gas and liquid transportation pathways.

In some embodiments, as illustrated in FIG. 4 and FIG. 13, the bristle plate 6 is defined with a spray nozzle 604, and a water pump 12 and a guide channel 8 are disposed in the liquid storage compartment 103. The spray nozzle 604 is in communication with a drain port of a water pump 25 disposed in the liquid storage compartment 103 via the guide channel 8. A microporous sheet 26 is built in one end of the guide channel 8 proximal to the spray nozzle 604. The water pump 25 is electrically connected to the circuit board 3, allowing the circuit board 3 to power the water pump 25. The water pump 25 pumps the liquid in the liquid storage compartment 103 into the guide channel 8, and the liquid is refined into droplets by the microporous sheet 26 at the end of the guide channel 8, allowing the droplets to be sprayed out from the spray nozzle 604. When a pet is grooming or rubbing its hair with the bristle component, the mist sprayed from the spray nozzle 604 wet the pet's hair, preventing the pet's hair from splashing.

In some embodiments, as illustrated in FIG. 15, the control switch on the control panel 13 includes a spray switch 1304. The spray switch 1304 includes a low-level switch 1304a, a medium-level switch 1304b, and a high-level switch 1304c. The intensity of the mist sprayed from the spray nozzle 604 can be adjusted by the three switches.

In some embodiments, as illustrated in FIG. 15, status icons on the control panel 13 are respectively a power indicator 1302 and a liquid level indicator 1301. The power indicator 1302 is configured to display the power of the pet hair remover. The liquid level indicator 1301 is configured to display the amount of water in the liquid storage compartment 103.

In some embodiments, the liquid level indicator 1301 is detected using a liquid level sensor. The liquid level sensor is disposed either in the liquid storage compartment 103 or the guide channel 8. The liquid level sensor is electrically connected to the circuit board 3. The water volume is displayed through a digital graphic interface, where after sensor detection, real-time liquid levels are visualized as a percentage-based numerical readouts on the control panel 13.

In some embodiments, the liquid level indicator 1301 directly displays the liquid level changes in the guide channel 8. The guide channel 8 is transparent, the liquid level indicator 1301 on the control panel 13 is partially designed as transparent, and the liquid level indicator 1301 is directly facing the transparent guide channel 8. The liquid level changes in the transparent guide channel 8 can be directly observed through the transparent liquid level indicator 1301.

In some embodiments, as illustrated in FIG. 11 and FIG. 13, a first ultraviolet lamp 103a is disposed in the liquid storage compartment 103, and the liquid storage compartment 103 can be sterilized by ultraviolet light emitted by the first ultraviolet lamp 103a.

In some embodiments, as illustrated in FIG. 11 and FIG. 13, a second ultraviolet lamp 10 is further disposed in the mounting compartment 101a. The storage compartment 101b can be sterilized by ultraviolet light emitted by the second ultraviolet lamp 10, or a pet's hair can be sterilized by the ultraviolet light when the pet rubs its hair.

In some embodiments, as illustrated in FIG. 11 and FIG. 13, one side, facing the mounting compartment 101a, of the adsorption portion 2 is arranged with a plurality of second ultraviolet lamps 10. The plurality of second ultraviolet lamps 10 are uniformly spaced in sequence along the adsorption portion 2, and each second ultraviolet lamp 10 is electrically connected to and powered by the circuit board 3. When a pet is grooming or rubbing its hair through the bristle component, the second ultraviolet lamp 10 sterilizes the pet's hair with ultraviolet light. When the user has cleaned the storage compartment 101b, the second ultraviolet lamp 10 can also emit ultraviolet light to sterilize the storage compartment 101b.

In some embodiments, as illustrated in FIG. 15, the control buttons on the control panel 13 further includes an ultraviolet switch 1303. The ultraviolet switch 1303 includes a first switch 1303a and a second switch 1303b. The first switch 1303a controls an operational mode of the first ultraviolet lamp 103a, enabling either manual on/off or programmable on/off. The second switch 1303b controls the operational mode of the second ultraviolet lamp 10, enabling either manual on/off or programmable on/off.

In some embodiments, as illustrated in FIG. 11 to FIG. 13, a pressing component is also designed in the pet hair remover. The pressing component includes a pressing member 14, a connecting member 16 and a spring 15. The housing 1 is defined with a second mounting groove 106 proximal to the first motor 4, and the spring 15 is disposed in the second mounting groove 106. The pressing member 14 abuts against the spring 15, and is coupled to the bristle plate 6 via the connecting member 16. When the pressing member 14 is pressed down, the spring 15 is compressed, driving the connecting member 16 to push the bristle plate 6 to be removed from the housing 1. In this manner, a user can clean the storage compartment 101b and remove the pet hair and other contaminants accumulated within the storage compartment 101b. When releasing the pressing member 14, the spring 15 is ready to be reset, the stored energy of the spring 15 enables the bristle plate 6 to be reconnected to the housing 1, thereby closing the storage compartment 101b.

In some embodiments, as illustrated in FIG. 11 to FIG. 13, the pressing component includes an electric push rod 23. A fixed end of the electric push rod 23 is installed on an inner wall of the mounting compartment 101a of the housing 1, and a telescopic end of the electric push rod 23 is installed on the connecting member 16. The electric push rod 23 is electrically connected to the circuit board 3. The control button on the control panel 13 includes a push rod switch 1306, which is configured to control the telescopic movement of the electric push rod 23. When a user needs to clean the pet hair, airborne particulates and other contaminants in the storage compartment 101b, the push rod switch 1306 on the control panel 13 controls the electric push rod 23 to extend and retract, and the connecting member 16 connected to the telescopic end of the electric push rod 23 drives the brush plate 6 to be detached from the housing 1. Thus, a user can clean the storage compartment 101b.

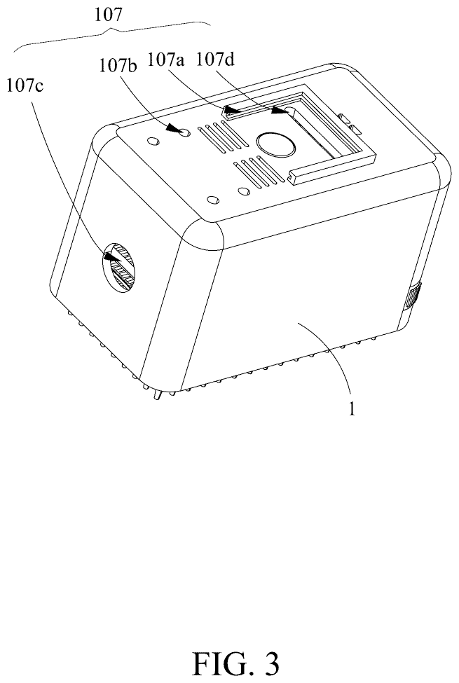

In some embodiments, as illustrated in FIG. 3, one side of the housing 1 is arranged with a connecting portion 107 configured to install the pet hair remover on a mounting platform to allow a pet to rub its hair when passing by.

In some embodiments, as illustrated in FIG. 3, the connecting portion 107 is an insertion slot 107a, which is defined by one side of the housing 1. An insertion plate 17 is removably inserted in the insertion slot 107a. The insertion plate 17 can be mounted via suction cups, magnetic adhesion, snap-fit connectors or threaded fastening mechanisms to areas where a pet often moves, including walls, furniture bases, sofas, doorways, pet access ways, pet houses, pet fences or pet tunnels.

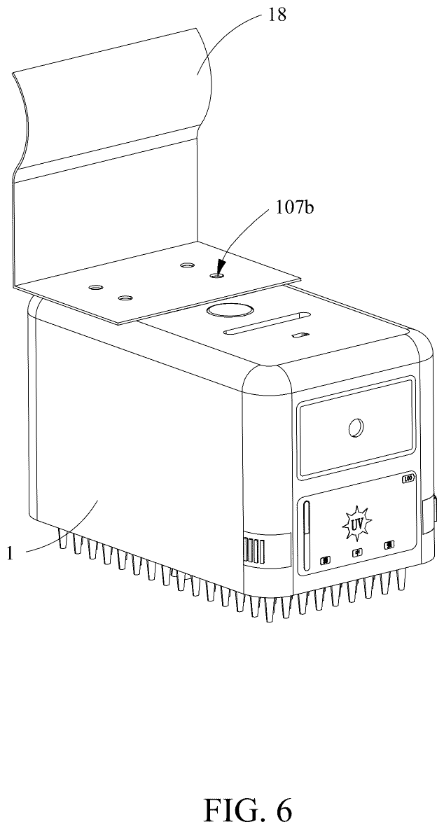

In some embodiments, as illustrated in FIG. 6, the connecting portion 107 includes a plurality of mounting holes 107b defined by one side of the housing 1. The housing 1 of the pet hair remover can be threadedly connected to a connecting plate 18 through the plurality of mounting holes 107b. The connecting plate 18 extends away from the housing. The connecting plate 18 is defined with an embedding groove, which is formed by at least two upward protrusions on a surface of the connecting plate 18 or formed by a recess on the surface of the connecting plate 18, thus allowing the connecting plate 18 to be embedded and connected with the mounting platform. The connecting plate 18 can be mounted via suction cups, magnetic adhesion, snap-fit connectors or threaded fastening mechanisms to areas where a pet often moves, including walls, furniture bases, sofas, doorways, pet access ways, pet houses, pet fences or pet tunnels. The fastening mechanisms include, such as, screws and bolts.

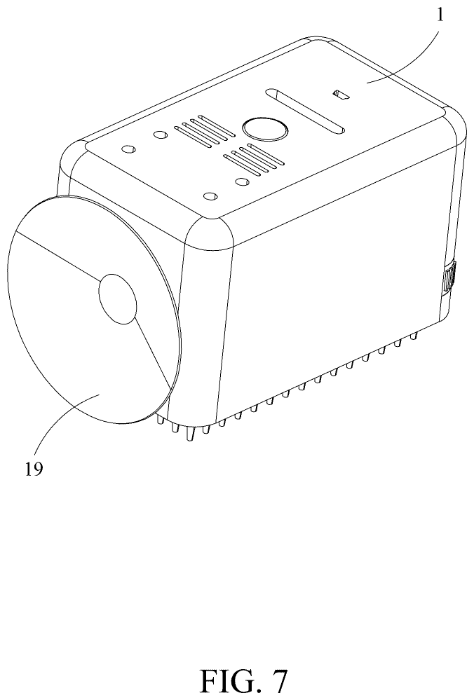

In some embodiments, as illustrated in FIG. 3 and FIG. 7, the connecting portion 107 is an insertion hole 107c, which is defined by one side of the housing 1. The insertion hole 107c of the housing 1 is inserted with a suction cup 19. The pet hair remover can be directly adsorbed, via the suction cup 19, on the mounting platform, which is usually an area where a pet often moves, such as walls, furniture bases, sofas, doorways, pet access ways, pet houses, pet fences or pet tunnels.

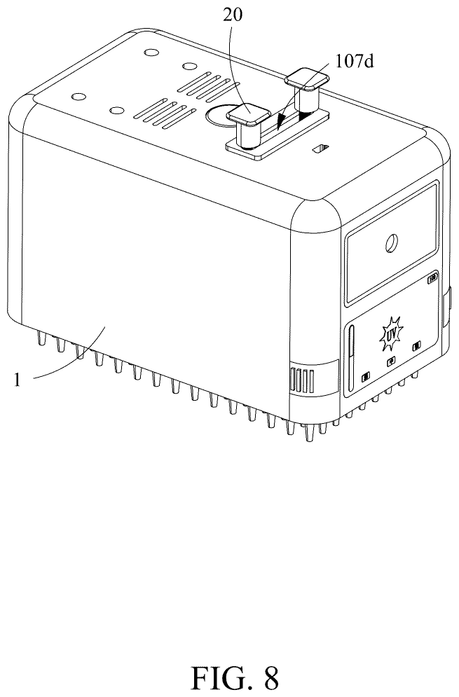

In some embodiments, as illustrated in FIG. 8, the connecting portion 107 is a snap-in slot 107d, which is defined by one side of the housing 1. A clamping member 20 can be snapped into the snap-in slot 107d so as to be detachably installed on the housing 1. The clamping member 20 is provided with an external thread, and the connecting portion 107 is provided with an internal thread. The clamping member 20 clamps the mounting platform between the clamping member 20 and the connecting portion 107 through a gasket, so that the pet hair remover can be directly clamped to the mounting platform through the clamping member 20. Usually, the mounting platform is an area where a pet often moves, such as walls, furniture bases, sofas, doorways, pet access ways, pet houses, pet fences or pet tunnels.

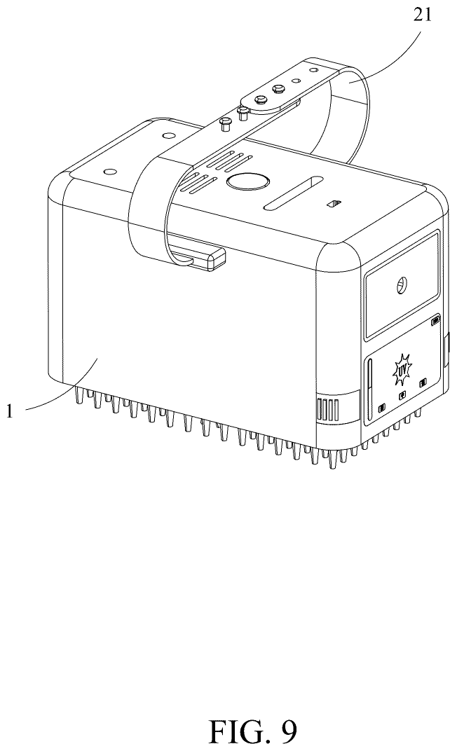

In some embodiments, as illustrated in FIG. 9, a strap 21 is provided on one side of the housing 1, and the strap has a tightening adjustment member. The pet hair remover can be directly tied to the mounting platform through the strap 21, which is usually an area where a pet often moves, such as walls, furniture bases, sofas, doorways, pet access ways, pet houses, pet fences or pet tunnels.

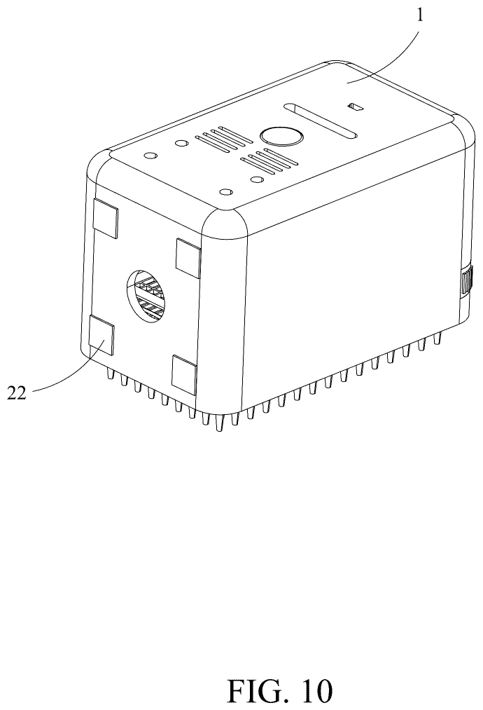

In some embodiments, as illustrated in FIG. 10, a magnetic component 22 is arranged on one side of the housing 1. The pet hair remover can be directly magnetically attached, via the magnetic component 22, to the mounting platform, which is usually an area where a pet often moves, such as walls, furniture bases, sofas, doorways, pet access ways, pet houses, pet fences or pet tunnels.

In some embodiments, the housing 1 of the pet hair remover is provided with a insertion slot 107a, a mounting hole 107b, a insertion hole 107c and a snap-in slot 107d, and the pet hair remover is optionally equipped with one or more of a insertion plate 17, a connecting plate 18, a suction cup 19, a clamping member 20, a strap 21 or a magnetic component 22. A user can choose the connection scheme of the pet hair remover based on actual using scenarios. The suction cup 19 can be a vacuum suction cup, a magnetic suction cup, an electrostatic suction cup or a rubber suction cup.

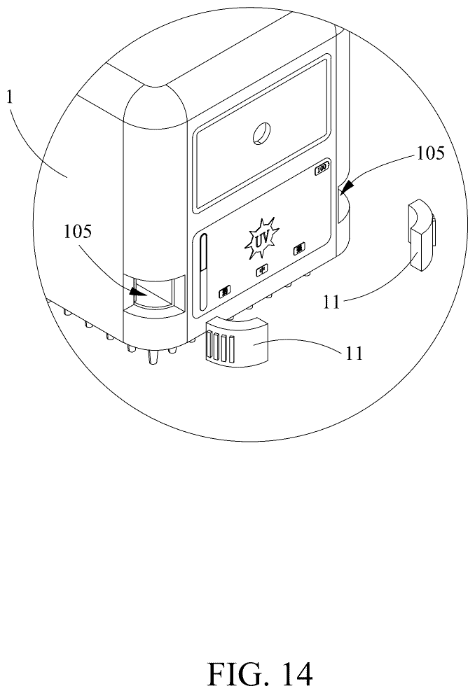

In some embodiments, as illustrated in FIG. 14, a fragrance chamber 105 is disposed inside the housing 1 or the bristle component, and the fragrance chamber is defined with a hole. Spherical fragrances or food are placed on opposite sides of an inner wall of the fragrance chamber to attract companion animals such as dogs and cats. The fragrance chamber 105 can be connected to the outside of the housing 1 through a detachable and insertable end cap 11. Catnip or food can be placed in the fragrance chamber 105 to attract pets nearby to use the pet hair remover for rubbing their hair.

In some embodiments, the pet hair remover establishes wireless connectivity with a user's smartphone through Wi-Fi or Bluetooth protocols. Alternatively, an application (APP) is developed for the user to remotely monitor and control the various functions of the pet hair remover. A high-precision hydrostatic level sensor is installed inside the liquid storage compartment 103 for real-time aqueous volume tracking. The user can observe the current water volume via the application and configure a low-level alert. When the water volume falls below a predetermined threshold, the application triggers a notification note to remind the user to replenish water in time.

A wind speed sensor is installed proximal to the fan blade 5 to monitor the hair suction intensity in real time. The user can view the current hair suction intensity through the application and manually adjust the fan blade speed as needed. When the sensor 12 detects that the pet's activity is enhanced, the system can automatically increase the fan blade speed to ensure efficient hair suction.

The spray intensity setting is selected through the spray switch 1304 on the control panel 13 to manually control the mist output. The sensor 12 can automatically activate or deactivate the spraying function by detecting a pet's proximity and grooming behaviors. The user can also remotely control the operation periods and precision adjustment of the mist output through the mobile phone application.

The speed mode of the brush roller 7 is selected through a scroll switch 1305 on the control panel 13, achieving a manual control of its working state. The sensor 12 detects pet behavior and automatically activate or deactivate the function of the brush roller 7. The user can also remotely adjust the speed and operating time of the brush roller 7 via the application to optimize the cleaning effectiveness. A skin detection sensor is installed on the pet hair remover to monitor real-time health indicators (e.g., moisture and temperature) of a pet's skin. The data collected by the sensor 12 is analyzed by the application to provides the user with pet skin health recommendations. When abnormalities are detected, the application issues an alert and suggests taking the pet to a veterinarian.

From the above description, it can be seen that the above-mentioned embodiments of the present disclosure achieve the following technical effects.

Compared with the related art, the pet hair remover proposed by the embodiments of the present disclosure can be secured in place for use. After being secured, the pet hair remover can be directly powered or charged via the USB interface. Through one or more combinations of the corresponding connecting portion 107, the strap 21 or the magnetic component 22 mounted on the housing 1, the user can install the pet hair remover in areas where pets often move, such as walls, furniture bases, doorways, pet access ways, pet houses, pet fences or pet tunnels, etc. The fragrance placed in the fragrance chamber 105 attracts pets to approach and rub their hair against the device. When a pet interacts with the pet hair remover, the sensor 12 detects the pet's behavior and transmit an electrical signal to the circuit board 3, activating the functions of the electronic components such as the fan blade 5, the atomizing sheet 9 or the water pump 25. During grooming, sterilization and disinfection by ultraviolet ray is applied to the hair. The spray switch 1304 on the control panel 13 controls the spray setting, and the first switch 1303a on the control panel 13 activates the first ultraviolet lamp 103a in the liquid storage compartment 103 to sterilize the liquid storage compartment 103. The alternating use of the bristle plate 6 and the bristle roller 7 directs shed hair into the storage compartment 101b by the fan blade 5. The scroll switch 1305 on the control panel 13 is configured to automatically activate of the bristle roller 7 by the sensor 12. When the storage compartment 101b needs to be cleaned, the brush plate 6 is removed from the housing 1 after the pressing member 14 is manually pressed, or the electric push rod 23 is controlled by the push rod switch 1306 on the control panel 13 to remove the brush plate 6 from the housing 1. After the storage compartment 101b is cleaned, the second switch 1303b on the control panel is configured to activate the second ultraviolet lamp 10 to disinfect the storage compartment 101b with ultraviolet irradiation. The above-mentioned process effectively reduces the hassle where the pet's hair is scattered when grooming or rubbing the hair, thereby effectively reducing the difficulty of cleaning.

The above description is only some embodiments of the present disclosure and is not intended to limit the present disclosure. For those skilled in the art, the present disclosure may have various changes and variations. Any modifications, equivalent substitutions, improvements, etc. made within the spirit and principles of the present disclosure should be included in the scope of protection of the present disclosure.

What is claimed is:

1. A pet hair remover, comprising:
a housing defining a first accommodating space inside, one side of the first accommodating space defining a mounting port to allow the first accommodating space to be in communication with an outside of the housing, the first accommodating space comprising a mounting compartment, a connecting portion being provided on one side of the housing, the connecting portion configured to be connected to a mounting platform;
a liquid storage compartment configured for storing a liquid;
a circuit board installed in the mounting compartment;
a bristle component comprising a bristle plate and a plurality of first brush heads, the bristle plate being disposed in the mounting port, the plurality of first brush heads being evenly distributed on one side of the bristle plate and extending to the outside of the housing, the bristle plate and/or the housing being provided with a spray nozzle and a detection member, and the spray nozzle communicating with the liquid storage compartment via a guide channel; and
an atomizer comprising an atomization element, the atomization element being disposed in the liquid storage compartment and/or the guide channel, the atomization element being electrically connected to the circuit board, and the atomization element configured to atomize the liquid in the liquid storage compartment; and
at least one sensor disposed in the detection member, the at least one sensor being electrically connected to the circuit board, and the at least one sensor comprising one or more of a visual sensor, an optical sensor, a pressure sensor, a chip sensor, an infrared sensor or a microwave sensor.

2. The pet hair remover according to claim 1, further comprising:
a storage compartment in communication with the outside of the housing through the mounting port; and
a control panel disposed in the housing and electrically connected to the circuit board, a function control area being provided on the control panel, and the function control area comprising a switch and a data indicator.

3. The pet hair remover according to claim 1, wherein the connecting portion comprises at least one mounting hole defined by a surface of the housing, and the connecting portion is configured to be detachably connected to the mounting platform through an engagement between a fastening member and the at least one mounting hole.

4. The pet hair remover according to claim 1, wherein the connecting portion comprises an insertion slot defined by a surface of the housing, and an insertion plate is configured to be inserted into the insertion slot to allow the housing to be detachably mounted to the mounting platform.

5. The pet hair remover according to claim 1, wherein the connecting portion comprises a snap-in slot defined by a surface of the housing, and the snap-in slot is configured to be detachably snap-fitted with a clamping member to allow the housing to be detachably clamped with the mounting platform.

6. The pet hair remover according to claim 1, wherein the connecting portion comprises a suction cup provided on a surface of the housing, and the housing is configured to be attached to the mounting platform through the suction cup.

7. The pet hair remover according to claim 1, wherein the connecting portion comprises a strap provided on a surface of the housing, and the strap is configured to be detachably tied to the mounting platform.

8. The pet hair remover according to claim 1, wherein the connecting portion comprises a connecting plate provided on a surface of the housing, and the connecting plate is configured to be detachably connected to or integrally formed with the housing.

9. The pet hair remover according to claim 1, further comprising a fragrance chamber, wherein the fragrance chamber is configured to place fragrance or food.

10. The pet hair remover according to claim 1, wherein the atomizing element comprises an atomizing sheet, and the atomizing sheet is disposed in an end of the guide channel proximal to a spray nozzle and is electrically connected to the circuit board.

11. The pet hair remover according to claim 1, wherein the atomizing element comprises a water pump, a water outlet of the water pump is in communication with the guide channel, the water pump is electrically connected to the circuit board, the atomizer comprises a microporous sheet, and the microporous sheet is disposed in an end of the guide channel proximal to the spray nozzle.

12. The pet hair remover according to claim 2, further comprising a hair suction component, wherein one side of the mounting compartment is defined with an air outlet, the mounting compartment is in communication with the outside of the housing through the air outlet, a peripheral of the housing and/or the bristle plate are/is defined with a plurality of flow grooves, an adsorption portion is provided between the mounting compartment and the storage compartment, the hair suction component is installed in the mounting compartment; the hair suction component comprises a first motor and a fan blade, the first motor is electrically connected to the circuit board, and the fan blade is installed on an output shaft of the first motor.

13. The pet hair remover according to claim 1, wherein each first brush head of the plurality of first brush heads is cylindrical, conical, pin-shaped or has a polygonal cross-section;
each first brush head of the plurality of first brush heads is integrally formed with the bristle plate or detachably connected to the bristle plate; and
a length of each first brush head of the plurality of first brush heads is ranged from 0.2 cm to 10 cm.

14. The pet hair remover according to claim 1, wherein a first ultraviolet lamp is disposed in the liquid storage compartment, and the first ultraviolet lamp is configured to sterilize the liquid in the liquid storage compartment.

15. A pet hair remover, comprising:
a housing defining a first accommodating space inside, a sidewall of the housing defining an air outlet and a mounting port in communication with the first accommodating space respectively, the first accommodating space comprising an mounting compartment and a hair storage space, the mounting compartment being in communication with an outside of the housing through the air outlet, the hair storage space comprising an adsorption portion and a storage compartment, the storage compartment being in communication with the outside of the housing through the mounting port, the adsorption portion being arranged between the mounting compartment and the storage compartment, a connecting portion being arranged on one side of the housing, and the connecting portion being configured to connect to a mounting platform;
a circuit board disposed in the mounting compartment;
a hair suction component disposed in the mounting compartment, the hair suction component comprising a first motor and a fan blade, the first motor being electrically connected to the circuit board, and the fan blade being mounted on an output shaft of the first motor; and
a bristle component comprising a bristle plate and a plurality of first brush heads, the bristle plate being arranged at the mounting port, the plurality of first brush heads being evenly distributed on one side facing away from the storage compartment of the bristle plate, and the plurality of first brush heads extending to the outside of the housing, the bristle plate and/or the housing being provided with a detection member, and a peripheral of the housing and/or the bristle plate defining a plurality of flow grooves; and
at least one sensor arranged at the detection member, the at least one sensor being electrically connected to the circuit board, and the at least one sensor comprising one or more of a visual sensor, an optical sensor, a pressure sensor, a chip sensor, an infrared sensor or a microwave sensor.

16. The pet hair remover according to claim 15, further comprising:
a second ultraviolet lamp disposed on one side away from the storage compartment of the adsorption portion and electrically connected to the circuit board, and an illumination range of the second ultraviolet lamp covers the first accommodating space.

17. The pet hair remover according to claim 15, further comprising:
a control panel arranged on the housing and electrically connected to the circuit board, wherein a function control area is arranged on the control panel, and the function control area comprises a switch and a data indicator.

18. The pet hair remover according to claim 15, wherein
each first brush head of the plurality of first brush heads is cylindrical, conical, pin-shaped or polygonal;
each first brush head of the plurality of first brush heads is integrally formed with the bristle plate or detachably connected to the bristle plate;
a length of each first brush head of the plurality of first brush heads is ranged from 0.2 cm to 10 cm.

19. The pet hair remover according to claim 15, wherein the connecting portion comprises at least one mounting hole defined by a surface of the housing, and the connecting portion is configured to be detachably connected to the mounting platform through an engagement between a fastening member and the at least one mounting hole.

20. The pet hair remover according to claim 15, wherein the connecting portion comprises an insertion slot defined by a surface of the housing, and an insertion plate is configured to be inserted into the insertion slot to allow the housing to be detachably mounted to the mounting platform.

21. The pet hair remover according to claim 15, wherein the connecting portion comprises a snap-in slot defined by a surface of the housing, and the snap-in slot is configured to be detachably snap-fitted with a clamping member to allow the housing to be detachably clamped to the mounting platform.

22. The pet hair remover according to claim 15, wherein the connecting portion comprises a suction cup provided on a surface of the housing, and the housing is configured to be attached to the mounting platform through the suction cup.

23. The pet hair remover according to claim 15, wherein the connecting portion comprises a strap provided on a surface of the housing, and the strap is configured to be detachably tied to the mounting platform.

24. The pet hair remover according to claim 15, wherein the connecting portion comprises a connecting plate provided on a surface of the housing, and the connecting plate is configured to be detachably connected to or integrally formed with the housing.

25. A pet hair remover, comprising:
a housing having a first accommodating space inside, the first accommodating space comprising a mounting compartment and a storage compartment, a connecting portion being provided on one side of the housing, the connecting portion being configured to connect with a mounting platform;
a circuit board being installed in the mounting compartment;
a bristle component comprising a bristle roller and a plurality of second brush heads, the bristle roller being pivoted to the mounting port, the plurality of second brush heads being evenly distributed on a circumferential surface of the bristle roller, a detection member being provided on the housing and/or the bristle component;
a hair suction component, a side of the mounting compartment away from the storage compartment defining an air outlet, the mounting compartment being communicated with an outside of the housing through the air outlet, a periphery of the housing and/or the bristle component defining a plurality of flow grooves, an adsorption portion being provided between the mounting compartment and the storage compartment, the hair suction component being installed in the mounting compartment, the hair suction component comprising a first motor and a fan blade, the first motor being electrically connected to the circuit board, and the fan blade being installed on an output shaft of the first motor;
the bristle component further comprising a second motor, a motor mounting platform being provided at a rotating shaft of the bristle roller, the second motor being coupled to the rotating shaft of the bristle roller through the motor mounting platform, and the second motor being electrically connected to the circuit board; and
at least one sensor disposed in the detection member, the at least one sensor being electrically connected to the circuit board, and the at least one sensor comprises one or more of a visual sensor, an optical sensor, a pressure sensor, a chip sensor, an infrared sensor or a microwave sensor.

26. The pet hair remover according to claim 25, wherein the bristle component further comprises a bristle plate and a plurality of first brush heads, the bristle plate is arranged at the mounting port, the plurality of first brush heads are evenly distributed on one side of the bristle plate away from the storage compartment, the detection member is arranged on the housing and/or the bristle component, the bristle plate defines a first mounting groove, and the bristle roller is pivoted to the bristle plate through the first mounting groove.

27. The pet hair remover according to claim 25, wherein each second brush head of the plurality of second brush heads is cylindrical, conical, pin-shaped or has a polygonal cross-section;
each second brush head of the plurality of second brush heads is integrally formed with the bristle plate or detachably connected to the bristle plate; and
a length of each second brush head of the plurality of second brush heads is ranged from 0.2 cm to 10 cm.

28. The pet hair remover according to claim 25, wherein the connecting portion comprises at least one mounting hole defined by a surface of the housing, and the connecting portion is configured to be detachably connected to the mounting platform through an engagement between a fastening member and the at least one mounting hole.

29. The pet hair remover according to claim 25, wherein the connecting portion comprises an insertion slot defined by a surface of the housing, and an insertion plate is configured to be inserted into the insertion slot to allow the housing to be detachably mounted to the mounting platform.

30. The pet hair remover according to claim 25, wherein the connecting portion comprises a snap-in slot defined by a surface of the housing, and the snap-in slot is configured to be detachably snap-fitted with a clamping member to allow the housing to be detachably clamped to the mounting platform.

31. The pet hair remover according to claim 25, wherein the connecting portion comprises a suction cup provided on a surface of the housing, and the housing is configured to be attached to the mounting platform through the suction cup.

32. The pet hair remover according to claim 25, wherein the connecting portion comprises a strap provided on a surface of the housing, and the strap is configured to be detachably tied to the mounting platform.

33. The pet hair remover according to claim 25, wherein the connecting portion comprises a connecting plate provided on a surface of the housing, and the connecting plate is configured to be detachably connected to or integrally formed with the housing.

34. The pet hair remover according to claim 25, further comprising a fragrance chamber, wherein the fragrance chamber is configured to place fragrance or food.

35. The pet hair remover according to claim 25, further comprising a second ultraviolet lamp, wherein the second ultraviolet lamp is installed on one side of the adsorption portion away from the storage compartment and is electrically connected to the circuit board, and an illumination range of the second ultraviolet lamp covers the accommodating space.

36. The pet hair remover according to claim 25, further comprising:
an atomizer comprising an atomizing element, and
a liquid storage compartment, a spray nozzle being provided on the housing and/or the bristle component, the spray nozzle being communicated with the liquid storage compartment via a guide channel, the atomizing element being disposed in the liquid storage compartment and/or the guide channel, the atomizing element being electrically connected to the circuit board, and the atomizing element being configured to atomize a liquid in the liquid storage compartment.

37. The pet hair remover according to claim 36, wherein the atomizing element comprises an atomizing sheet, the atomizing sheet is disposed in one end of the guide channel proximal to the spray nozzle, and the atomizing sheet is electrically connected to the circuit board.

38. The pet hair remover according to claim 36, wherein the atomizing element comprises a water pump, a water outlet of the water pump is communicated with the guide channel, the water pump is electrically connected to the circuit board, the atomizer further comprises a microporous sheet, the microporous sheet is disposed in one end of the guide channel proximal to the spray nozzle.

39. The pet hair remover according to claim 25, further comprising:
a control panel arranged on the housing and electrically connected to the circuit board, wherein the control panel defines a function control area, and the function control area comprises a switch and a data indicator.
